(19) United States
(12) Patent Application Publication
(10) Pub. No.: US 2010/0325662 A1
(43) Pub. Date: Dec. 23, 2010

(54) SYSTEM AND METHOD FOR NAVIGATING POSITION WITHIN VIDEO FILES

(76) Inventor: Harold Cooper, Somerville, MA (US)

Correspondence Address: DICKSTEIN SHAPIRO LLP, 1825 EYE STREET NW, Washington, DC, 20006-5403, US

(21) Appl. No.: 12/488,212

(22) Filed: Jun. 19, 2009

(51) Int. Cl. G06F 13/00

(52) U.S. Cl. 725/38

(57) ABSTRACT

A video navigation system that provides substantial video context to enable a user to more accurately navigate to the relevant portion of the video. A user is provided with visual content that is temporally and spatially organized. By moving a pointer either horizontally or vertically along the time-organized content a user can change the view to enable more accurate selection of position within a video.

### FIELD OF THE INVENTION

The embodiments disclosed herein relate to a system architecture and a method to facilitate navigating video files and selecting a desired position within the file for conducting additional tasks.

### BACKGROUND OF THE INVENTION

Vast amounts of information are increasingly available in video format. When locating desired data within videos the most common method for navigating is a scroll-bar beneath the video that allows the user to select a certain point on the video. If the user does not wish to view the entire video from the beginning and continuing to the end, then the user is generally required to select a certain point along the scroll bar. Once the point is selected the user has to wait for the video window (typically located over the scroll bar) to load the selected portion of the video. Once loaded, the user can determine whether or not this is the portion of the video she wishes to see. If it is not, the cycle starts anew. This cycle is both time consuming and frustrating for the user.

Similarly, even when a user is familiar with a video's content, quick and precise location of a certain scene may be difficult. For example, when editing home videos for archiving, a user often wishes to eliminate irrelevant portions of the video file. Even though the editor is often the same person who filmed the video, she is often left to search for the desired portion in a way very similar to that set forth above. Without a better method she must manipulate numerous controls (play, pause, rewind, fast-forward, and stop) to reach the precise point in the video where she wishes to start archiving.

A factor in these inefficient methods is the user typically having only one information source for choosing the appropriate location along the scroll bar. A user is generally provided with the total length of the video (for example 10:34), and with this information can determine how far in to the video she wishes to advance as a percentage of the total length. Once this point is selected a frame is generally provided, and from that point the user can move forward or back depending on where in relation to the selected frame the desired portion of the video is. Without prior knowledge of the video, however, user selections are merely guesses regarding the composition of the video and where within the video the desired information for viewing is located. The end result is a user either wasting time watching portions of the video she is not interested in, or the user missing a portion of the video that she should have viewed or archived.

One method currently employed for providing a user additional context is to provide a subset of the video as still frames. This alone simplifies the task of determining where within a video file the desired information is located. This method is currently used on commercially produced DVDs to allow scene selection. A viewer is provided with knowledge regarding the scene's contents by the picture, and usually a short description below the picture. This method requires selecting and describing specific frames so that the video can be divided into chapters. As such, this method is unsuitable for low-production quality online videos, or even high-quality shorter videos that do not warrant the time and effort necessary to divide a video into chapters.

Instead of forcing users to make choices using only the overall length and percentage of the video that the user wishes to forego viewing, the user is better served by an interactive scroll bar that provides more useful information to enable a user to make educated choices regarding which portion of the video is relevant for the user's purpose. Unlike currently employed methods of providing video context, an ideal method would: allow user interaction so that a user can gain additional information; be applicable to videos of all lengths and quality; and allow for retroactive application to any video no matter its format or origin.

### SUMMARY OF THE INVENTION

The SpaceTime Scrubber is a video navigation system that provides a user substantial context of a video's makeup so that a user may more accurately navigate to the portion of the video relevant to the user. The SpaceTime Scrubber combines computer hardware and software to present the user with an image made from space time frames of the original video. These space time frames are organized from left to right to provide temporal and spatial context of where within the video the selected frame occurs. In addition to providing visual time-organized and space-organized content, the SpaceTime Scrubber allows user interaction. A user, by moving the pointer either horizontally or vertically along the scrubber filmstrip window can change the user's view of the space time frames. Horizontal movement along the scrubber filmstrip window advances or reverses the user to space time frames generated from video frames extracted from beginning- or end-portions of the video. Vertical movement from the top to the bottom of the scrubber filmstrip window results in changes to the zoom level and provides a user with greater clarity. Once a user finds the correct position, she can click the pointer to select that frame. This results in the video being loaded at the selected frame.

### BRIEF DESCRIPTION OF THE DRAWINGS

These and other embodiments are described by the following figures and detailed description.

FIG. 1 illustrates system hardware and software involved in the preliminary processing for implementing the invention.

FIG. 2 illustrates a progress bar and sample code for implementing the progress bar.

FIG. 3 illustrates source space time frames and sample code for producing source space time frames.

FIG. 4A illustrates user interface frames and sample code for producing user interface frames.

FIG. 4B illustrates source space time frames and user interface frames.

FIG. 5 illustrates sample code for placing a destination video into system memory as an array.

FIG. 6 illustrates sample code for creating a parameter window.

FIG. 7 illustrates sample code for generating and organizing user interface frames based on pointer position within the scrubber filmstrip window.

FIG. 8 illustrates sample code for a translator.

FIG. 9 illustrates sample code for implementing a linear zoom.

FIG. 10 illustrates sample code for implementing a non-linear zoom.

FIG. 11 illustrates a user interface for a SpaceTime Scrubber.

FIG. 12 is a graph providing four example spacetimePoly curves at different zooms, all centered on t₀=0.2.

FIG. 13 illustrates a computer system.

FIG. 14 illustrates sample code for the insertion or removal of frames.

FIG. 15 illustrates sample code for creating a single image with a column from each image of a certain number of images.

### DETAILED DESCRIPTION OF THE INVENTION

In the following detailed description, reference is made to the accompanying drawings, which form a part hereof and illustrate specific embodiments that may be practiced. In the drawings, like reference numerals describe substantially similar components throughout the several views. These embodiments are described in sufficient detail to enable those skilled in the art to practice them, and it is to be understood that structural and logical changes may be made. The sequence of steps is not limited to that set forth herein and may be changed or reordered, with the exception of steps necessarily occurring in a certain order.

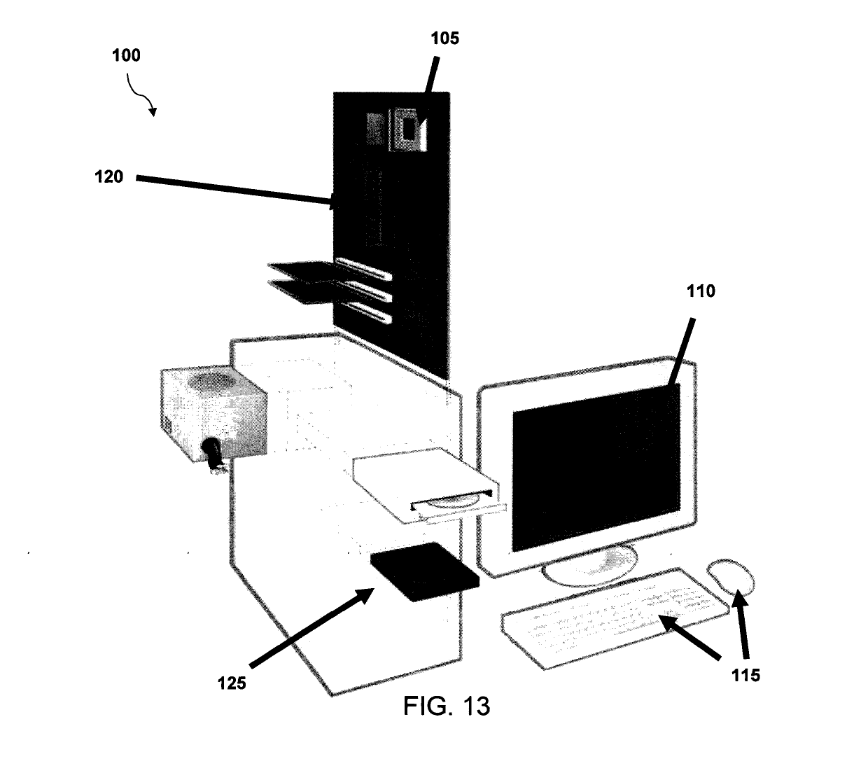

Referring now to FIG. 13, embodiments described herein are designed to be used with computer systems and generally include a computerized method or computer program product on a computer readable medium that contains computer program logic. The computer systems may include any computer system, for example, a personal computer 100, a minicomputer, a mainframe computer, or mobile devices. The computer system will typically include: at least one processor 105; a display 110; an input device 115 (i.e., a computer mouse or keyboard); computer memory including random access memory (RAM) 120, hard drive memory 125, and possibly mass storage memory devices and subsystems, but may include more or fewer of these components. The processor 105 can be directly connected to the display, or remotely over communication lines such as telephone lines, local area networks, or any other network for data transmission (i.e., an internet connection). The invention may be implemented with a variety of computing hardware. Embodiments may include both commercial off-the-shelf (COTS) configurations, and special purpose systems designed to work with the embodiments disclosed herein. So long as the hardware and software used is capable of performing the tasks required by specific embodiments, the embodiments are within the scope of the invention.

The description includes figures that contain example code for accomplishing certain tasks. This code is not intended to be limiting, and only represents an example method for accomplishing the associated tasks. Numerous other methods using different program languages, commands, code sequences, compilers, etc. may be employed to accomplish the same task.

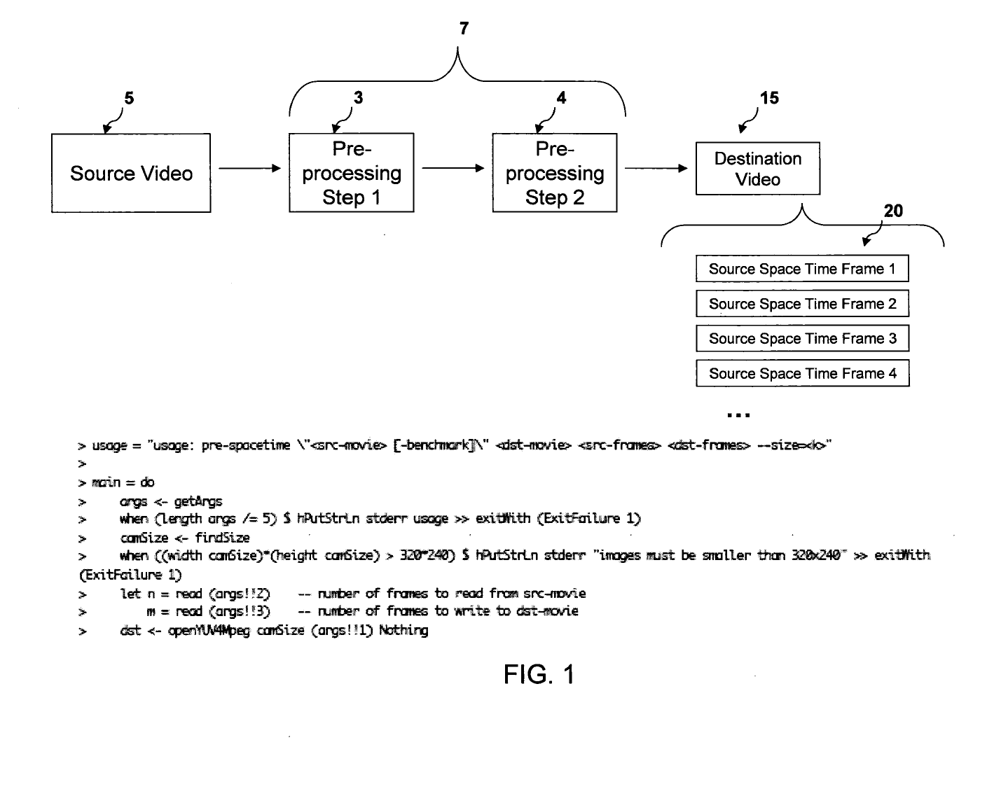

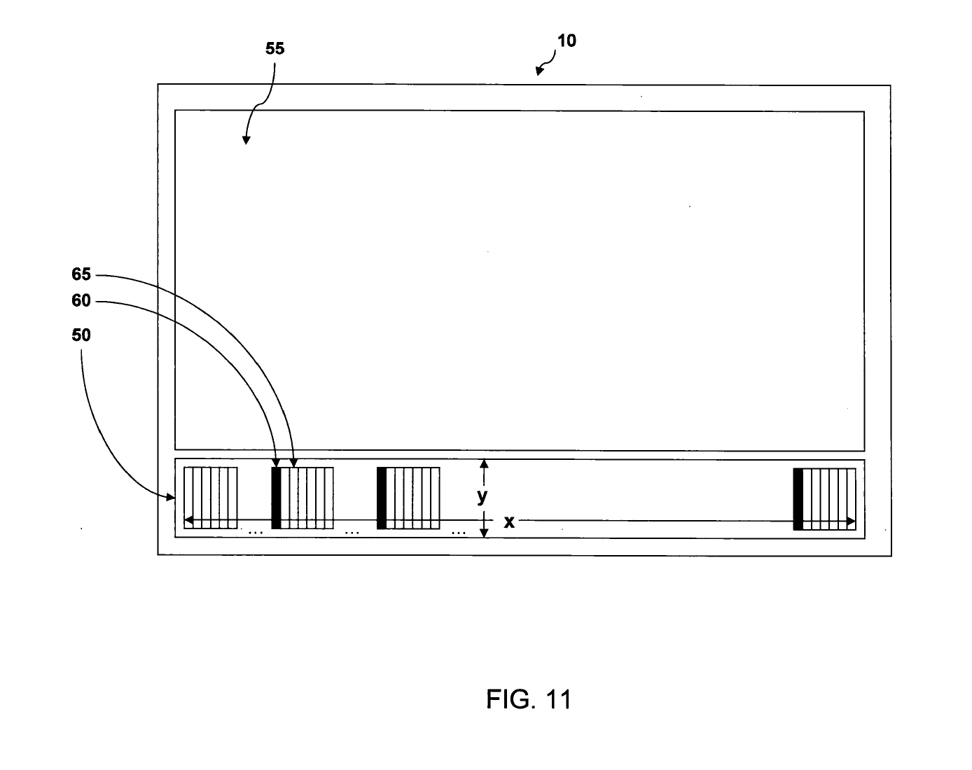

Referring to FIG. 1, a source video 5 is selected for eventual use with the SpaceTime Scrubber 10 (FIG. 11). A list of potential source videos 5 may be compiled by a source video locator module, or the source video 5 may be directly selected. The source video locator module can be implemented in hardware form or as a software program. The source video 5, however, is generally too large in its native format for use by the SpaceTime Scrubber 10 (FIG. 11), which will be described in further detail in FIG. 11. Consequently, the SpaceTime Scrubber 10 (FIG. 11) may perform a preliminary processing step 7 that results in a significantly smaller destination video 15. The preliminary processing step 7 may include preliminary processing first step 3, which could include reducing the source video 5 frame size from, for example 640×480 pixels to 64×48 pixels, thereby reducing the source video frame size by a factor of 100. Even if this initial step is performed, however, preliminary processing second step 4 may also be necessary. The preliminary processing step 7 may include either preliminary processing first step 3 or preliminary processing second step 4, or both preliminary processing first step 3 and preliminary processing second step 4. The destination video 15, when preliminary processing second step 4 is performed, becomes a collection of source space time frames 30 instead of containing a subset of frames from the source video 5. Preliminary processing second step 4 is described in greater detail below.

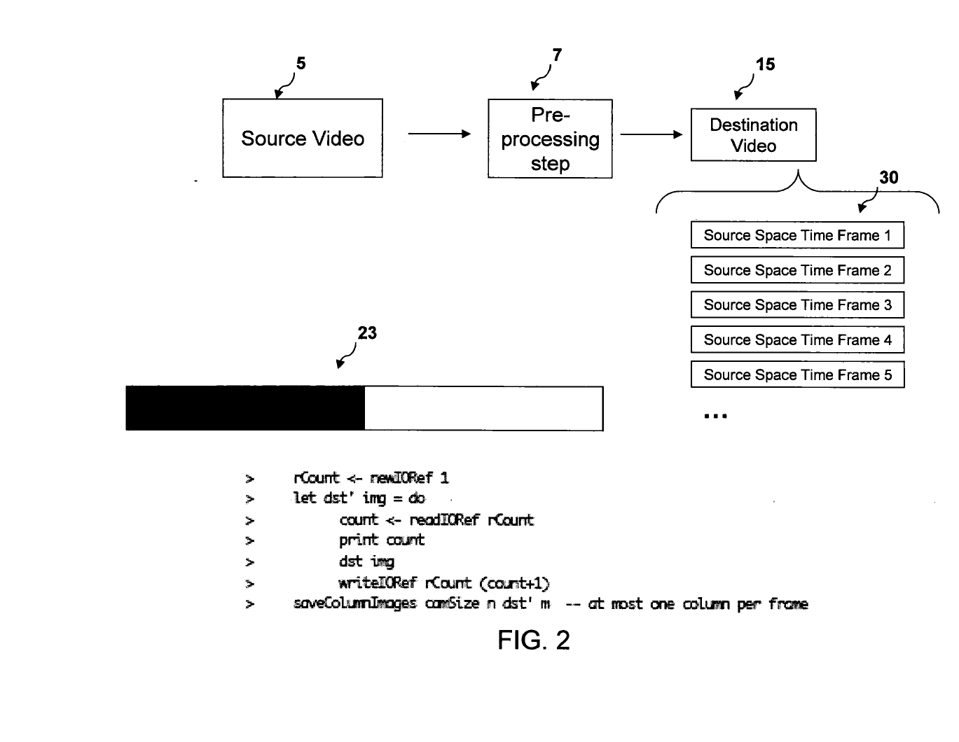

Referring now to FIG. 2, the preliminary processing step 7 (FIG. 1) is the most processor 105 (FIG. 13) resource intensive and processing time-consuming step of the SpaceTime Scrubber 10 (FIG. 11). Consequently, to keep users apprised of the progress of the preliminary processing step 7 (FIG. 1) the SpaceTime Scrubber 10 (FIG. 11) displays its progress with a progress bar 23 that advances each time a new frame is generated. The progress bar 23 approximates what portion of the preliminary processing step 7 (FIG. 1) is completed by the computer processor 105 (FIG. 13). Five source space time frames 30 have been processed and the SpaceTime Scrubber 10 (FIG. 11) has approximated that ten are necessary, accordingly the progress bar 23 displays the preliminary processing step 7 as approximately halfway completed. FIG. 2 also provides sample code for implementing the progress bar. It should be noted that the SpaceTime Scrubber processing can be accomplished by a specialized processor device that processes frames in parallel or through a high-speed processor pipeline or other high-speed architecture.

Additionally, it is important to note that pre-processing only needs to be done once for a given video if the results from the pre-processing are stored, for example on a hard drive or on a DVD. In these situations, where the pre-processing has already been accomplished, a user would not have to wait for the pre-processing to be completed. Similarly, in a situation where a video is being downloaded or streamed, a content provider could send the results of any pre-processing done by the content provider. By doing so, the content provider would avoid making a user wait for the entire video to be downloaded so that pre-processing could be performed locally by the user. Instead, the user would benefit from the pre-processing already completed by the content provider, and would have nearly immediate access pre-processing results.

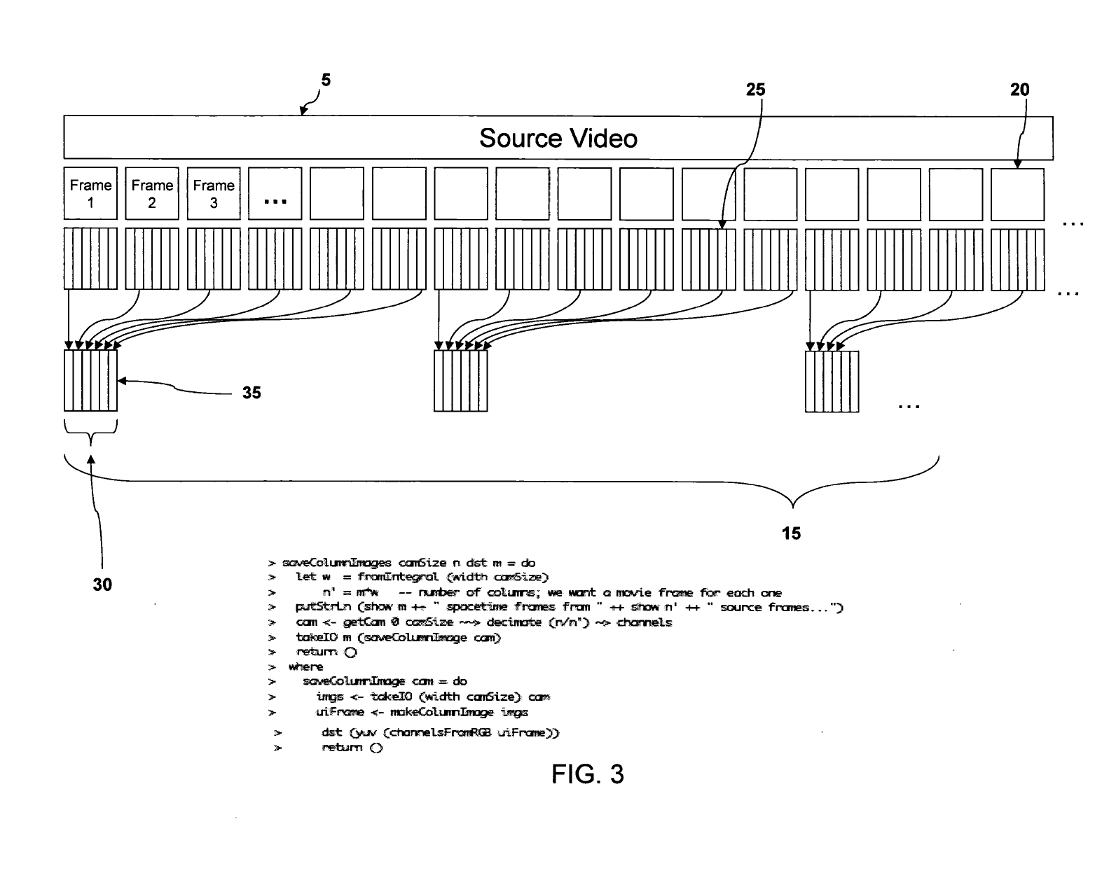

Referring now to FIG. 3, a more detailed explanation of preliminary processing second step 4 (FIG. 1) of the source video 5 is shown. The source video 5 is made up of source frames 20. A source frame 20 is one of many single photographic images in a source video 5. Generally, twenty-four source frames 20 are needed for one second of source video 5, though this amount varies widely based on the quality of the source video 5. The source frame 20 can be divided into a number of source columns 25. A source column 25 is a vertical section of the source frame 20 with a predefined width.

If the source video 5 has 150,000 source frames 20 (only sixteen are shown in FIG. 3), with each source frame 20 having 1000 source columns 25 (only five are shown in FIG. 3), then the source video 5 has 150,000,000 source columns 25. If one source column 25 is taken out of each of the 150,000 source frames 20, then a total of 150,000 source columns 25 are removed for processing. If these source columns 25 are put end-to-end with the first source column 25 on the left and the final source column 25 on the right, then the destination video 15 is created. The destination video 15 consists of 150 source space time frames 30, each with 1000 source space time columns 35 (only five are shown in FIG. 3). Example code for preliminary processing second step 4 is shown in FIG. 1.

As shown in FIG. 3, the source space time columns 35 within the source space time frames 30 will have the same spatial-organization. The i^{th} column of a source frame 20 of the source video 5 will occupy the i^{th} column of a source space time frame 30. By strictly applying this fundamental principle, spatial integrity is maintained because anything located on the left side of frame from the original video will maintain the same position within any source space time frame 30 it appears in.

Additionally, no source column 25 from the source video 5 is placed out of time-sequence from other source columns 25 selected for placement within the source space time frames 30. That is, a later-occurring source space time column 35 from the source video 5 will not appear before an earlier-occurring source space time column 35, and an earlier-occurring source space time column 35 will not appear after a later-occurring source space time column 35. Applying this fundamental principle results in the SpaceTime Scrubber 10 (FIG. 11) maintaining temporal integrity for each of its source space time columns 35.

As shown in FIG. 3, the source space time frames 30 are not simply 150 source frames 20 that are selected and removed as a whole source frame 20 from the source frames 20 of the original 150,000 from the source video 5. Instead, they are 150 composite frames, each source space time frame 30 being made up of, for example, at least one column from one thousand consecutive frames of the original 150,000 source frames 20. Each space time frame 30 represents specific source columns or chosen source columns of the original source columns 25. The selection of source columns 25 for including in the source space time frame 30 and the preliminary processing step 7 (FIGS. 1, 2) may be conducted by a space time frame generator module.

For example, a space time frame generator module may determine that the first source space time frame 30 of the 150 composite frames should be made up of one column from each of frames 000,001 through 001,000 of the original 150,000 source frames 20 of the source video 5. Similarly, a space time frame generator module may determine that the 150th source space time frame 30 of the 150 composite frames should be made up of one column of source frames 20 149,001 through 150,000. Other compositions of the source space time frames 30 are also possible.

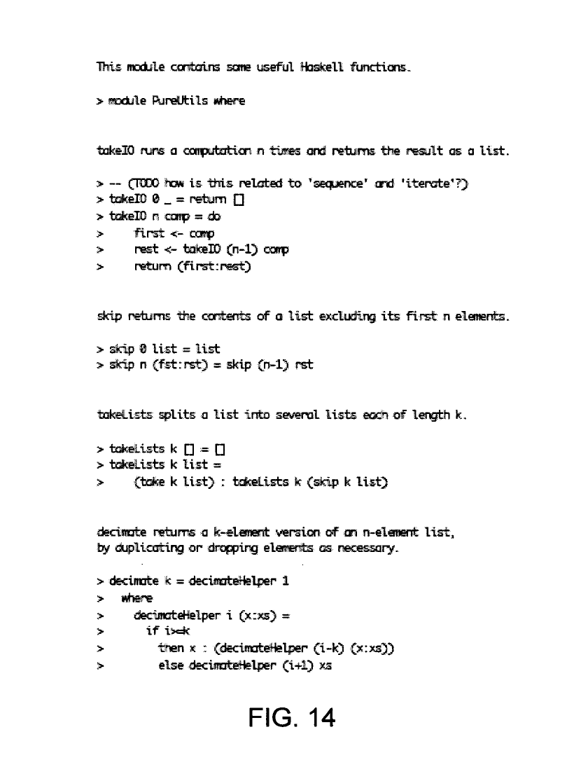

Example source code for accomplishing these processes is shown in FIG. 3. In this source code saveColumnImages uses “decimate” (see FIG. 14) from PureUtils to cause the source video 5 to have n′=m*w frames, which represents one frame for each column in the destination video 15. The “decimate” program has the capability to either remove source frames 20 or add source frames 20 as a simple form of interpolation to ensure that the correct number of source frames 20 is present. Once the source video 5 is converted into destination video 15, then destination video 15 is further divided into source space time frames 30 consisting of a set number of source space time columns 35. These space time frames 30 and space time columns 35 are referred to as source space time frames 30 and source space time columns 35 because both are directly derived from the source video 5. A source space time column 35, however, is identical to its corresponding source column 25. The designation of “source space time column 35” indicates that the column was selected for reorganization into a source space time frame 30 for inclusion in the destination video 15.

Referring again to FIG. 2, the preliminary processing step 7 described above is not mandatory for source video 5. It is possible for the SpaceTime Scrubber 10 (FIG. 11) to use a source video 5 without the source video 5 having undergone the preliminary processing step 7. The preliminary processing step 7, however, is valuable and preferred for source video 5. In cases where the preliminary processing step 7 is not performed, the video used with the SpaceTime Scrubber 10 (FIG. 11) is a source video 5 as opposed to a destination video 15. For ease of explanation, this description references only destination video 15, but it is to be understood that the preliminary processing step 7 is not mandatory. Instead of a destination video 15 which has undergone the preliminary processing step 7, a source video 5 that has not undergone the preliminary processing step 7 may also be used.

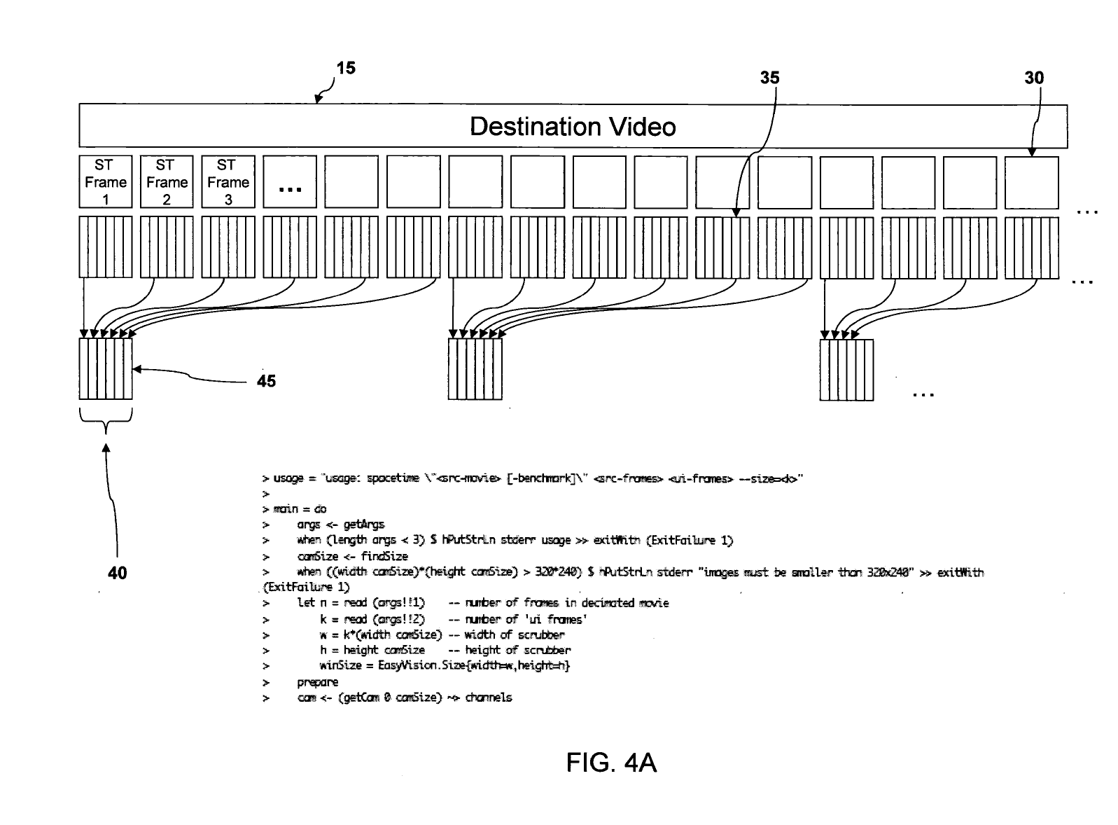

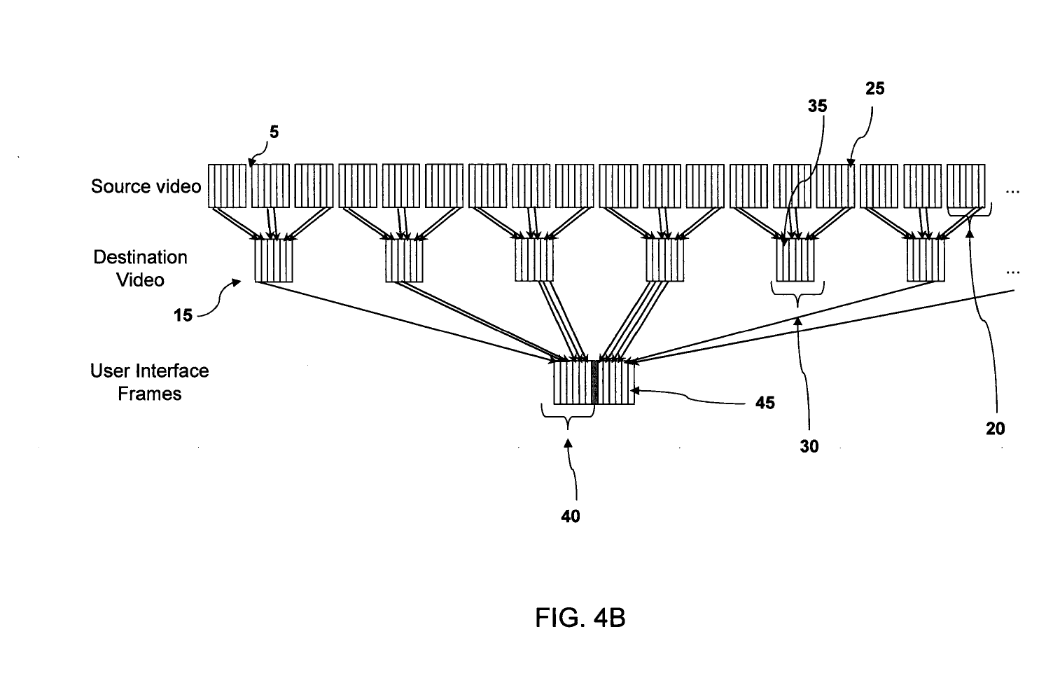

Referring now to FIG. 4A, once a destination video 15 has been identified, the SpaceTime Scrubber 10 (FIG. 11) generates user interface frames 40 from the destination video 15. These user interface frames 40 are generated in just the same way as the source space time frames 30 of the source video 5 are generated. The user interface frames 40 are referred to as user interface frames 40 because they are the actual frames viewed in scrubber filmstrip window 50 (FIG. 11) of the SpaceTime Scrubber 10 (FIG. 11). The user interface frames 40 consist of a set number of user interface columns 45. As presented for the source space time column 35, a user interface column 45 is identical to its corresponding source column 25. The designation of “user interface column 45” indicates that the column was selected for reorganization into a user interface frame 40 for eventual display in the scrubber filmstrip window 50 (FIG. 11). The user interface frames 40, like the source space time frames 30, are space time frames. That is, the user interface frames 40, despite the reorganization of their component source columns 25 (FIG. 3), maintain their temporal and spatial integrity. FIG. 4A shows example code that can be used to generate a set number of user interface frames 40. FIG. 4B shows how source columns 25 from source frames 20 of a source video 5 may be selected for use in a destination video 15 as a source space time column 35 in a source space time frame 30, and ultimately be selected for use as a user interface column 45 in a user interface frame 40.

User interface columns 45 are identical to the source space time columns 35, which are identical to the original source columns 25 (FIG. 3). The source column 25 (FIG. 3) itself has not undergone any changes. Designating a source column 25 (FIG. 3) a source space time column 35 merely denotes the column's selection from the source video 5 (FIG. 3) to be included in the destination video 15. Designating a column a user interface column 45 merely denotes the column's selection for inclusion in the scrubber filmstrip window 50 (FIG. 11). Both source space time frames 30 and user interface frames 40 maintain their temporal and spatial integrity.

Individual user interface frames 40 need to have the same dimensions as the source frames 20 (FIG. 3). The scrubber filmstrip window 50 (FIG. 11), however, is generally a short, wide control beneath the video window 55 (FIG. 11). This requires that multiple user interface frames 40 be strung together to create the scrubber filmstrip window 50 (FIG. 11) that includes a collection of user interface frames 40. The zoom function is still applied to the entire scrubber, but its assignments are split up among the different user interface frames 40 so that each user interface frame 40 can maintain proper geometry. If necessary for clarity, this can be shown to a user by separating the frames by black columns 63 (FIG. 11), similar to how the frames would appear if they were part of a filmstrip.

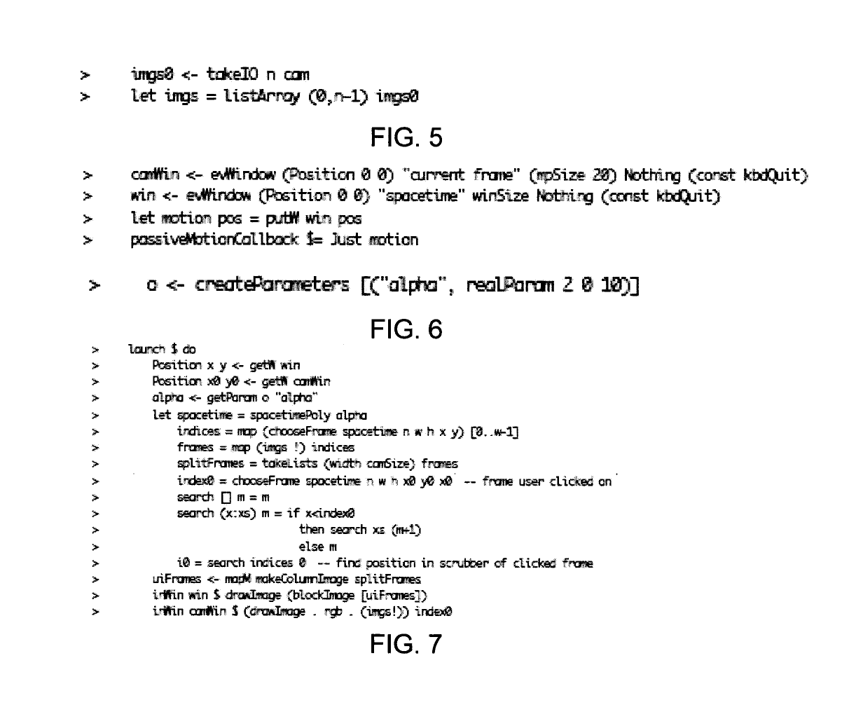

In addition to being used to form user interface frames 40, the destination video 15 (or the source video 5 in embodiments where no preliminary processing step 7 (FIGS. 1, 2) is done) is stored as an array in the system random access memory 120 (FIG. 13). A video array generator module, implemented in application-specific hardware or platform-independent software, may organize the source video in the array for accessibility by the scrubber filmstrip window 50 (FIG. 11). Storage as an array in system random access memory 120 (FIG. 13) is necessary to ensure that the SpaceTime Scrubber 10 (FIG. 11) has a prompt response to pointer movements. The requirement to place the source video 5 entirely in memory is what necessitates, in most cases, performing the preliminary processing step 7 (FIGS. 1, 2) to reduce the size of the source video 5 into a destination video 15. Referring now to FIG. 5, this example code demonstrates how the SpaceTime Scrubber 10 (FIG. 11) places the destination video 15 into system memory as an array.

Referring now to FIG. 11, the SpaceTime Scrubber 10 consists of two windows. The first is the video window 55. The video window 55 is where the source video 5 (FIG. 1) plays. The second is the scrubber filmstrip window 50. The scrubber filmstrip window 50 is where a series of user interface frames 40 (FIG. 4A) are placed. A window generator may create the video window 55 and the scrubber filmstrip window 50.

An optional third window (not shown) is a parameter window. The parameter window includes a slider control that is used to adjust zoom level sensitivity function being used. For example, if ‘z=1+alpha*(max 0 y)’ is used as the zoom factor, then alpha is an adjustable parameter that determines how strongly vertical pointer motion will affect zoom. This example has z always being greater than or equal to 1. By keeping z equal to or greater than one, when the pointer is not located within the scrubber filmstrip window 50 then the scrubber filmstrip window 50 is completely zoomed out so that subsets of the entire video are shown linearly. Adjusting the slider control to a higher setting will result in a set downward pointer movement creating more zoom. Similarly, adjusting the slider control to a lower setting results in a set downward pointer movement creating less zoom. Referring now to FIG. 6, this example code demonstrates how the SpaceTime Scrubber 10 could create a parameter window to adjust zoom functions.

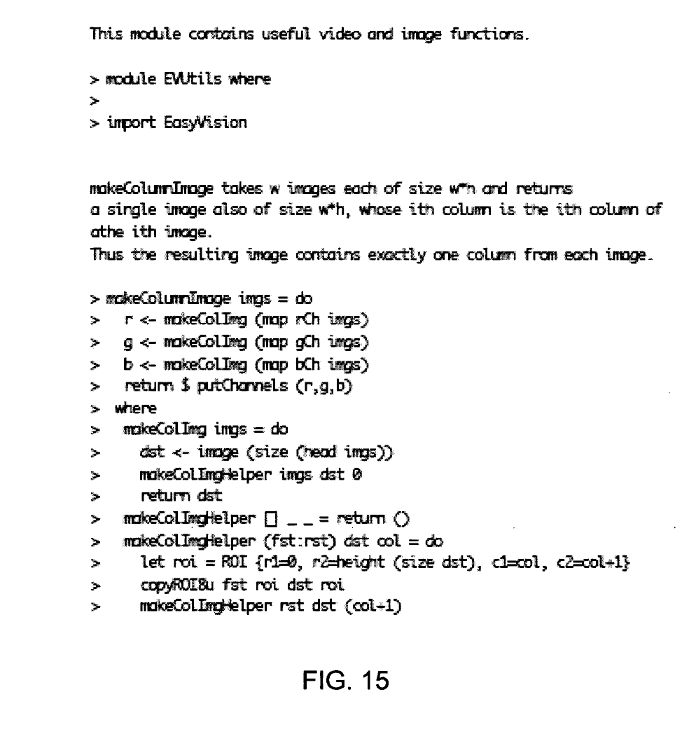

Once the video window 55 and scrubber filmstrip window 50 of the SpaceTime Scrubber 10 are generated, a pointer position module enters a loop that uses the pointer position module to continually check pointer position and generate and organize the user interface frames 40 (FIG. 4A) based on vertical pointer position and horizontal pointer position within the scrubber filmstrip window 50. As presented above, y (vertical pointer position) determines the amount of zoom, while x (horizontal pointer position) determines the focus time t0, which also impacts the zoom function. The zoom function (spacetimePoly) is applied to each filmstrip column 65 in the scrubber filmstrip window 50 to assign a particular user interface frame 40 (FIG. 4A) to each filmstrip column 65 in the scrubber filmstrip window 50. The assignment of each particular user interface frame 40 (FIG. 4A) is then split up among the several user interface frames 40 (FIG. 4A) in the SpaceTime Scrubber 10, and the user interface frames 40 (FIG. 4A) are generated using “makeColumnImage” (see FIG. 15) from EVUtils. MakeColumnImage takes “w” images each of size w*h and returns a single image containing exactly one column from each image.

Finally, the user interface frames 40 (FIG. 4A) are combined into one image using blockImage and drawn, and the current frame (that frame where the pointer currently resides) is also drawn. Referring now to FIG. 7, this example code demonstrates how the SpaceTime Scrubber 10 (FIG. 11) generates and organizes the user interface frames 40 (FIG. 4A) based on pointer position within the scrubber filmstrip window 50 (FIG. 11).

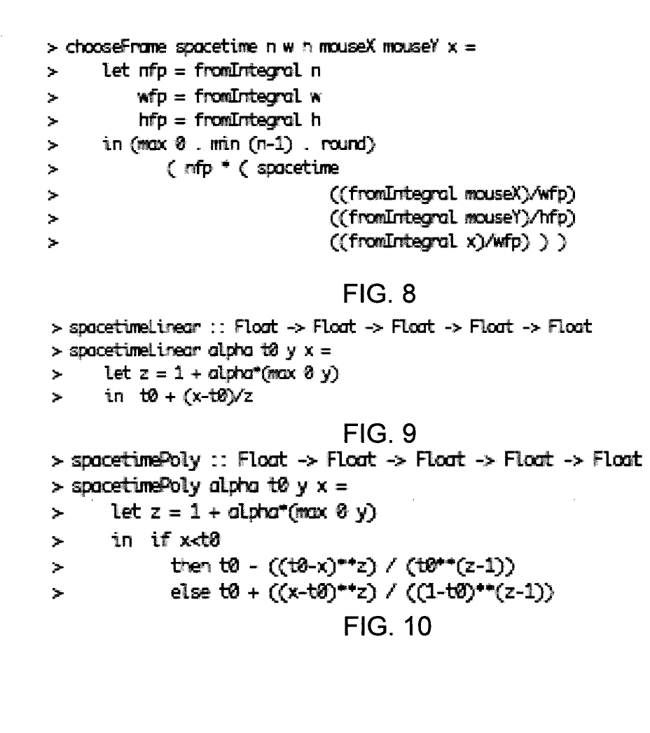

The SpaceTime Scrubber 10 (FIG. 11) uses a translator to match pointer coordinates with the frame numbers used by the source video 5 (FIG. 1), and also with the [0,1] ranges used by the zoom function. The translator in this particular embodiment is chooseFrame. Referring now to FIG. 8, this example code illustrates a translator.

There are many possible zoom functions for allowing the amount of zoom to be varied based on the vertical position of the pointer, with two examples provided here. The first is a basic linear zoom. A linear zoom simply zooms the entire scrubber filmstrip window 50 (FIG. 11.) uniformly around a frame that is being focused on. Referring now to FIG. 9, this example code illustrates a linear zoom embodiment. The second, and generally preferred possibility, zooms around the frame that is focused on, but uses less zoom further away from the focus area. Using less zoom at the ends of scrubber filmstrip window 50 (FIG. 11) enables at least small portions of the entire video to remain visible in the scrubber filmstrip window 50 (FIG. 11) even if much of the left and right edges of the scrubber filmstrip window 50 (FIG. 11) are reduced in size due to maximum zooming on the area of focus. Referring now to FIG. 10, this example code illustrates a second method for zooming.

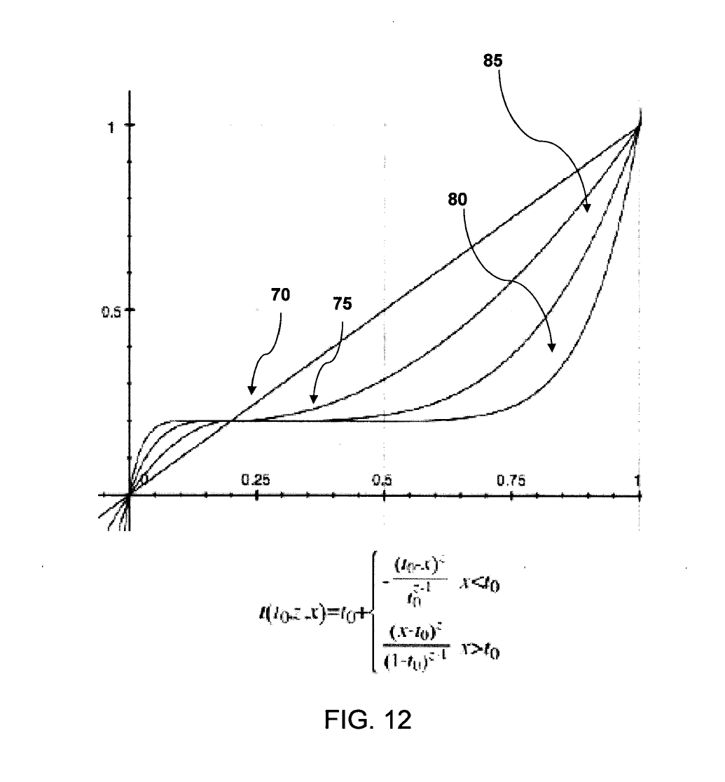

Referring now to FIG. 12, the graph provides four example spacetimePoly curves at different zooms, all centered on t₀=0.2. The formula for each of the curves is shown in FIG. 12. The z=1 curve 70 is a straight line from (0,0) to (1,1), independent of t₀. This curve corresponds to the scrubber filmstrip window 50 (FIG. 11) when there is no zoom, and the entire video is distributed uniformly along the scrubber. As the zoom level (z) increases, the curves become flatter and flatter around t₀, assigning more and more of the scrubber filmstrip window 50 (FIG. 11) to frames around that time. For example, the curve y4(x)=t (0.2, 8, x) 80 is virtually flat from x=0.25 to x=0.60. For each curve, regardless of zoom, the curve passes through (0,0) which assigns the beginning of source video 5 (FIG. 1) to the beginning of the scrubber filmstrip window 50 (FIG. 11), and also through (1,1) which assigns the end of the source video 5 (FIG. 1) to the end of the scrubber filmstrip window 50 (FIG. 11). The curve y2(x)=t (0.2,2,x) 75, and curve y3(x)=t (0.2,4,x) 85 are also shown in FIG. 12.

The above description and drawings illustrate embodiments which achieve the objects, features, and advantages described. Although certain advantages and embodiments have been described above, those skilled in the art will recognize that substitutions, additions, deletions, modifications and/or other changes that may be made.

What is claimed as new and desired to be protected by Letters Patent of the United States is:

1. An apparatus for navigating position within video comprising:
a processor for analyzing a source video comprising source frames made of source columns, wherein the processor generates a scrubber filmstrip window comprising space time frames, wherein the space time frames comprise selected source columns, the selected source columns having the same relative column positions in the space time frames that the selected source columns occupied in the source frames, and wherein all the selected source columns have the same temporal location relative to other of the selected source columns within the scrubber filmstrip window;
random access memory for storing the source video as an array;
a user interface for presenting the scrubber filmstrip window; and
an input device to allow a pointer to move over the scrubber filmstrip window wherein horizontal movement changes an area of focus and vertical movement changes a zoom level.

2. The apparatus of claim 1 wherein the processor conducts preliminary processing on the source video to create a destination video.

3. The apparatus of claim 2 wherein the preliminary processing conducted by the processor comprises a preliminary processing first step that reduces a source video frame size.

4. The apparatus of claim 2 wherein the preliminary processing conducted by the processor comprises a preliminary processing second step that removes a second set of selected source columns that includes the selected source columns, wherein the second set of selected source columns is compiled into a second set of space time frames, and wherein the second set of selected source columns have the same column position within the second set of space time frames that the source columns occupied within the source frames.

5. The apparatus of claim 2 wherein the preliminary processing conducted by the processor generates a progress bar on the user interface to indicate an approximate percentage of completion of the preliminary processing.

6. The apparatus of claim 1 wherein the random access memory and the processor are separated by an internet connection.

7. The apparatus of claim 1 wherein the user interface includes a video window for displaying the source video.

8. The apparatus of claim 1 wherein the input device and the processor are separated by an internet connection.

9. A server for a website enabling scene selection within video comprising:
a user interface comprising a scrubber filmstrip window comprising user interface columns combined to form a plurality of user interface frames;
memory for storing a source video, wherein the source video contributes the user interface columns;
a processor for compiling source columns from the source video into the plurality of user interface frames, wherein the user interface columns have the same relative column positions in the plurality of user interface frames that the source columns occupied in a source frame, and wherein the user interface columns are in the same temporal location relative to other of the user interface columns selected for the scrubber filmstrip window; and
random access memory for storing the plurality of user interface frames to enable prompt loading of the plurality of user interface frames when a pointer position is changed in relation to the scrubber filmstrip window.

10. The server of claim 9 further comprising a pointer position module to track movements of the pointer position over the scrubber filmstrip window wherein horizontal movement changes an area of focus and vertical movement changes a zoom level.

11. The server of claim 10 wherein the pointer position module responds to the movements of a computer mouse.

12. The server of claim 9 wherein the memory is a hard drive memory.

13. The server of claim 9 wherein the memory and the processor are separated by an internet connection.

14. The server of claim 9 wherein the plurality of user interface frames of the scrubber filmstrip window are separated by columns.

15. The server of claim 9 wherein the user interface includes a video window for displaying the source video.

16. The server of claim 10 wherein the user interface includes a parameter window comprising a slider control to adjust the zoom level sensitivity.

17. A computerized method for navigating position within video comprising:
presenting a source video from a computer memory, wherein the source video comprises source frames made of source columns;
using a processor to select specific source columns from the source frames of the source video for use as user interface columns in user interface frames, wherein the user interface columns are in the same temporal location relative to other of the user interface columns, and wherein the user interface columns have the same relative column position in the user interface frames that they occupied in the source frames;
displaying the user interface frames in a scrubber filmstrip window, wherein a horizontal pointer position in the scrubber filmstrip window determines an area of focus within the scrubber filmstrip window and a vertical pointer position in the scrubber filmstrip window determines a zoom level within the scrubber filmstrip window.

18. The method of claim 17 wherein using the processor further comprises a preliminary processing of the source video to create a destination video.

19. The method of claim 18 wherein the preliminary processing of the source video comprises a preliminary processing first step that reduces source video frame size.

20. The method of claim 18 wherein the preliminary processing of the source video comprises a preliminary processing second step that removes a second set of selected source columns that includes the specific source columns, wherein the second set of selected source columns is compiled into a second set of space time frames, and wherein the second set of selected source columns have the same column position within the second set of space time frames that the source columns occupied within the source frames.

21. The method of claim 18 wherein the preliminary processing of the source video further comprises displaying a progress bar to indicate an approximate percentage of completion of the preliminary processing.

22. The method of claim 17 wherein the horizontal pointer position and the vertical pointer position within the scrubber filmstrip window determines a portion of the source video for viewing within a video window.

23. The method of claim 17 further comprising displaying a slider control within a parameter window of a user interface to adjust the zoom level sensitivity.

24. The method of claim 17 wherein when the horizontal pointer position is outside the scrubber filmstrip window or the vertical pointer position is outside the scrubber filmstrip window the scrubber filmstrip window is displayed with no zoom.

25. A computer program product having a computer readable medium with computer program logic recorded thereon for navigating position within video, the computer program logic comprising:
a source video locator module for identifying a source video comprising a source frame made up of source columns;
a space time frame generator module for selecting choosing a source column from the source video to form space time frames for display in a scrubber filmstrip window, wherein a chosen source column is placed in the same relative column position in a space time frame that the source column occupied in the source frame, and wherein the chosen source column is in the same temporal location relative to another chosen source column selected for the scrubber filmstrip window;
a video array generator module for organizing the source video for access by the scrubber filmstrip window;
a pointer position module for tracking a position of a pointer within the scrubber filmstrip window, wherein a horizontal pointer position determines an area of focus within the scrubber filmstrip window and a vertical pointer position determines a zoom level within the scrubber filmstrip window.

26. The computer program product of claim 25 wherein the space time frame generator module conducts preliminary processing on the source video to create a destination video.

27. The computer program product of claim 26 wherein the preliminary processing conducted by the space time frame generator module comprises a preliminary processing first step that reduces source video frame size.

28. The computer program product of claim 26 wherein the preliminary processing conducted by the space time frame generator module comprises a preliminary processing second step that removes a second set of chosen source columns that includes the chosen source column, wherein the second set of chosen source columns is compiled into a second set of space time frames, and wherein the second set of chosen source columns have the same column position within the second set of space time frames that the source columns occupied within the source frame.

29. The computer program product of claim 25 wherein the space time frames of the scrubber filmstrip window are separated by columns.

30. The computer program product of claim 25 wherein the pointer position module indicates no zoom level when either the horizontal pointer position or the vertical pointer position is outside the scrubber filmstrip window.

31. The computer program product of claim 25 wherein the video array generator module organizes the source video within random access memory for access by the scrubber filmstrip window.

32. The computer program product of claim 25 further comprising a window generator for generating the scrubber filmstrip window and a video window.
